(19) United States
(12) Patent Application Publication
(10) Pub. No.: US 2023/0023200 A1
(43) Pub. Date: Jan. 26, 2023

(54) SURFACE TREATMENT COMPOSITION FOR VIBRATION DAMPING STEEL SHEET AND VIBRATION DAMPING STEEL SHEET

(71) Applicant: POSCO, Pohang-si, Gyeongsangbuk-do (KR)

(72) Inventors: Jin-Tae Kim, Gwangyang-si, Jeollanam-do (KR); Jung-Hwan Lee, Pohang-si, Gyeongsangbuk-do (KR); Yeong-Seon Kim, Gwangyang-si, Jeollanam-do (KR); Ha-Na Choi, Gwangyang-si, Jeollanam-do (KR); Yang-Ho Choi, Gwangyang-si, Jeollanam-do (KR)

(73) Assignee: POSCO, Pohang-si, Gyeongsangbuk-do (KR)

(21) Appl. No.: 17/782,426

(22) PCT Filed: Oct. 15, 2020
(86) PCT No.: PCT/KR2020/014103

§ 371 Date: Jun. 3, 2022

(30) Foreign Application Priority Data
Dec. 11, 2019 (KR) 10-2019-0164858

(51) Int. Cl. C09D 7/61; C09D 7/62; C09D 167/00

(52) U.S. Cl. CPC C09D 7/61; C09D 7/62; C09D 167/00

(57) ABSTRACT

The present disclosure is to provide a vibration damping steel sheet having improved vibration damping performance. Provided according to the present disclosure are: a surface treatment composition for a vibration damping steel sheet, comprising a polymer resin and inorganic nano particles having a mean aspect ratio (L/D) of 100 or more; and a vibration damping steel sheet surface-treated with the composition.

### TECHNICAL FIELD

The present disclosure relates to a surface treatment composition for a vibration damping steel sheet and a vibration damping steel sheet.

### BACKGROUND ART

A vibration damping steel sheet is a steel sheet which blocks external noise or vibrations, and is used in various fields, for example, outer plates of household appliances making a lot of noise such as a refrigerator, a washing machine, or an air purifier, automotive parts such as an engine oil pan or a dash panel which are the main cause of car noise, precision instruments, building materials, and the like.

The vibration damping steel sheet generally includes a constrained vibration damping steel sheet manufactured by laminating a polymer resin between two steel sheets and a non-constrained vibration damping steel sheet in which a polymer resin is applied or laminated on one steel sheet, and the constrained vibration damping steel sheet and the non-constrained vibration damping steel sheet are different in a method of implementing vibration damping performance. External noise or vibrational energy is converted into thermal energy by shear deformation of the polymer resin laminated between steel sheets in the constrained vibration damping steel sheet ((a) of FIG. 1), or by stretch deformation of the polymer resin applied on a steel sheet in the non-constrained vibration damping steel sheet ((b) of FIG. 1).

As the conventional technology related to the vibration damping steel sheet, technologies using a polyester resin (Japanese Patent Laid-Open Publication No. (Sho) 51-93770), using a polyamide resin (Japanese Patent Laid-Open Publication No. (Sho) 56-159160), and using ethylene/a-olefin and crosslinked polyolefin (Japanese Patent Laid-Open Publication No. (Sho) 59-152847), are known in the art. The conventional technologies implemented vibration damping performance using a viscoelastic effect of a polymer resin. Under the background as such, the inventors of the present disclosure intended to improve vibration damping performance, thereby deriving the present disclosure.

### DISCLOSURE

### Technical Problem

The purpose of the present disclosure is to provide a steel sheet surface treatment composition which may improve vibration damping performance of a steel sheet.

### Technical Solution

According to an aspect of the present disclosure, a surface treatment composition for a vibration damping steel sheet includes: a polymer resin and inorganic nanoparticles having a mean aspect ratio (L/D) of 100 or more.

According to another aspect of the present disclosure, a vibration damping steel sheet includes: a steel sheet and a vibration damping layer containing the surface treatment composition on at least one surface of the steel sheet.

### Advantageous Effects

As set forth above, according to an exemplary embodiment in the present disclosure, inorganic nanoparticles having a mean aspect ratio (L/D) of 100 or more are applied in the manufacturing of a vibration damping steel sheet, thereby providing a vibration damping steel sheet which may convert external vibrational energy into thermal energy by a polymer resin interfacial slip to block external vibrations or noise.

### DESCRIPTION OF DRAWINGS

FIG. 1 is drawings illustrating a principle of blocking external vibrational energy of a conventional vibration damping steel sheet. In FIG. 1, (a) is a constrained vibration damping steel sheet and (b) is a non-constrained vibration damping steel sheet.

FIG. 2 is a drawing illustrating that when external force is applied to a conventional vibration damping steel sheet, vibrations or cracking occur in the steel sheet.

FIG. 3 is a drawing illustrating that when external force is applied to a vibration damping steel sheet of the present disclosure, inorganic nanoparticles cause a slip in a polymer resin interface.

FIG. 4 is a drawing illustrating that when external force is applied to a constrained vibration damping steel sheet and a non-constrained vibration damping steel sheet according to the present disclosure, inorganic nanoparticles cause a slip in a polymer resin interface.

FIG. 5 is drawings illustrating vibration damping performance of (a) a steel sheet, (b) the conventional vibration damping steel sheet, and (c) the vibration damping steel sheet according to the present disclosure.

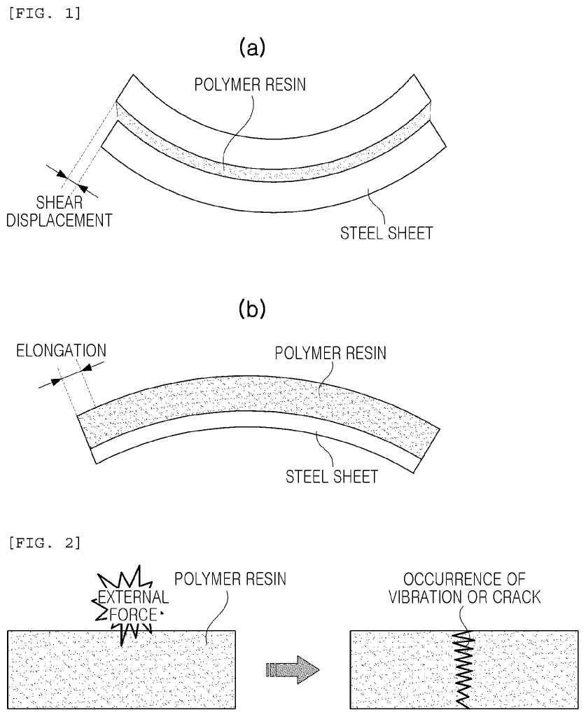

### BEST MODE FOR INVENTION

Hereinafter, exemplary embodiments in the present disclosure will now be described in detail. However, the exemplary embodiments in the present disclosure maybe modified in many different forms and the scope of the disclosure should not be limited to the embodiments set forth herein.

The present disclosure relates to a composition for surface treatment of a vibration damping steel sheet including a polymer resin and inorganic nanoparticles. According to the present disclosure, an interfacial slip effect of the inorganic nanoparticles having a high aspect ratio (L/D) as well as a viscoelastic effect of the polymer resin may be used to implement the vibration damping performance of the steel sheet.

The vibration damping steel sheet includes a constrained vibration damping steel sheet manufactured by laminating a polymer resin molded in a film form between two steel sheets and a non-constrained vibration damping steel sheet in which a polymer resin is applied or laminated on one steel sheet. The polymer resin applied to the vibration damping steel sheet has a viscoelastic effect, and converts vibrational energy into thermal energy by shear deformation or stretch deformation. As the polymer resin, one or more resins selected from the group consisting of an ethylene vinyl acetate resin, a polyethylene resin, a polypropylene resin, a polyvinyl butyral resin, a polyester resin, a polyvinyl chloride resin, and an epoxy resin may be used.

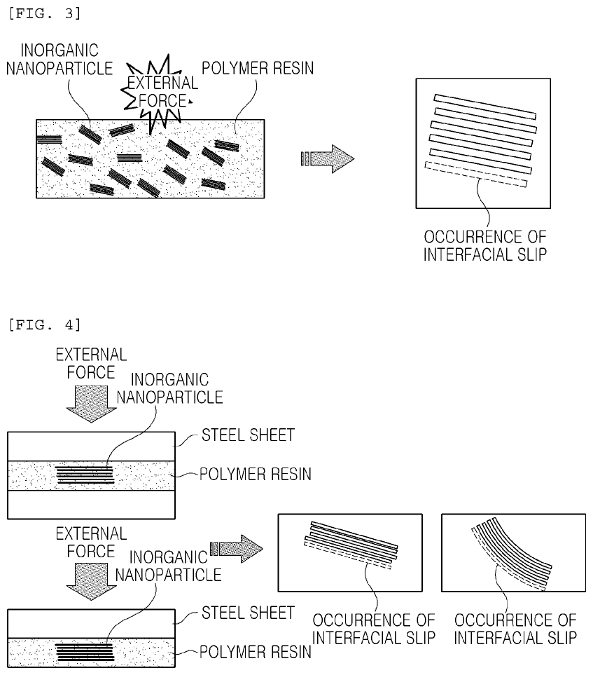

Meanwhile, in the case in which particles of the polymer are used alone in the manufacturing of the vibration damping steel sheet, when external force such as vibration and noise is applied to the steel sheet, vibration occurs in a vibration damping layer due to the brittle properties of the polymer resin and further, a crack may occur (FIG. 2).

However, as shown in FIG. 3, in the case in which a composition in which a polymer resin and inorganic nanoparticles having a high mean aspect ratio (L/D) are mixed is used to manufacture a vibration damping steel sheet, a crack does not easily occur even when external force is applied to the steel sheet. This is because the polymer resin and the inorganic nanoparticles are mixed to cause a hardening effect, thereby improving mechanical properties of the polymer resin such as strength and hardness. That is, the inorganic nanoparticles having a high mean aspect ratio (L/D) according to the following Equation (1) may improve the strength of a soft area of the polymer resin and make a brittle area harder, thereby complementing the mechanical properties of the polymer resin:

σ_{c}=σ_{f}+V_{f}θ+α[1−(1/D)/{2(L/D)}]+σₘ(1−V_{f}) Equation (1)

σ_{c}: mechanical properties of composite

σ_{f}: mechanical properties of inorganic nanoparticles

σₘ: mechanical properties of polymer resin

V_{f}: volume fraction of inorganic nanoparticles

θ: orientation coefficient of inorganic nanoparticles

α: strength factor constant of inorganic nanoparticles

L/D: mean aspect ratio

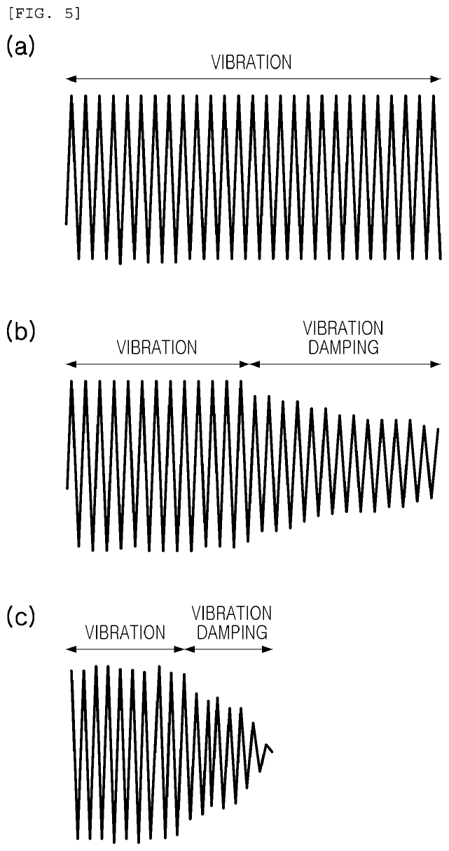

Furthermore, the inorganic nanoparticles having a high aspect ratio (L/D) increases a contact area with the polymer resin, thereby also increasing a slip force with a polymer resin interface. That is, as shown in FIG. 4, external vibrational energy is converted into thermal energy by a slip occurring on the polymer resin interface, thereby implementing improved vibration damping performance.

In order to implement the vibration damping performance as described above, inorganic nanoparticles having a mean aspect ratio (L/D) of 100 or more may be used, and the kind of inorganic nanoparticles is not particularly limited, but preferably, may be one or more selected from the group consisting of graphite nanofiber, carbon nanotubes, nano clay, and graphene.

In the surface treatment composition of the present disclosure, the inorganic nanoparticles may be included at 0.1 to 20 parts by weight with respect to 100 parts by weight of the polymer resin. When the content of the inorganic nanoparticles is less than 0.1 parts by weight, it is difficult to express vibration damping performance which is to be implemented in the present disclosure, and when the content is more than 20 parts by weight, the viscosity of the composition is increased, so that it is difficult to form the vibration damping layer.

In addition, the composition may further include an additive which is generally used for steel sheet surface treatment, and for example, may further include a wetting agent, a defoaming agent, a crosslinking agent, an antioxidant, and the like.

Next, a vibration damping steel sheet having a vibration damping layer formed using the composition for surface treatment of a vibration damping steel sheet will be described. The vibration damping layer may be formed by molding the composition into a film form and laminating the film, or applying a liquid composition, on at least one surface of a steel sheet. In addition, the vibration damping layer may be formed by molding the composition into a film form and laminating the film, or applying a liquid composition, between steel sheets.

In the case of the vibration damping layer molded into a film form, the polymer resin is melted by heating to its melting point or higher, the inorganic nanoparticles are uniformly mixed therewith (melt brand method), and the mixture is molded into a film form. Mixing conditions may be appropriately adjusted depending on the melting point of the polymer resin, and the thickness of the film is preferably 25 to 200 μm. When a vibration damping layer molded into a film form is manufactured, an ethylene vinyl acetate resin, a polyethylene resin, a polypropylene resin, a polyvinyl butyral resin, and the like may be used as a preferred polymer resin.

Meanwhile, when the polymer resin is a liquid, an appropriate amount of inorganic nanoparticles are uniformly mixed, and then the mixture is applied to a thickness of 1 to 200 μm, thereby forming the vibration damping layer. In this case, a polyester resin, a polyvinyl chloride resin, an epoxy resin, and the like may be preferably used.

The steel sheet is not particularly limited in the present disclosure, but a cold rolled steel sheet, a hot rolled steel sheet, a galvanized steel sheet, a zinc alloy plated steel sheet, a stainless steel sheet, an aluminum plate, and the like may be used, and generally the thickness of the metal plate maybe about 0.2 to 1.2 mm.

When the polymer resin and the inorganic nanoparticles having a mean aspect ratio (L/D) of 100 or more are applied to the vibration damping steel sheet as in the present disclosure, vibrational energy is converted into thermal energy by the viscoelasticity of the polymer resin and the slip of the inorganic nanoparticles, thereby securing the vibration damping performance (FIG. 4).

### MODE FOR INVENTION

### EXAMPLE

Hereinafter, the Examples of the present disclosure will be described in detail. The following Examples are only illustrative of the present disclosure, and do not limit the scope of the present disclosure.

1. Manufacturing of Coating Solution and Film for Forming Vibration Damping Layer

### (1) Example 1

10 g of nanoclay having a mean aspect ratio (L/D) of 100 (Aldrich) and surface-modified with trimethyl stearyl ammonium was added to 100 g of a polyester resin, and then the mixture was uniformly dispersed at a speed of 3000 rpm in a high-speed agitator, thereby preparing a coating solution. The thus-prepared coating solution was used to form a film having a thickness of 100 μm.

### (2) Example 2

1 g of carbon nanotubes having a mean aspect ratio (L/D) of 500 were added to 100 g of a polyester resin, and then the mixture was uniformly dispersed at a speed of 3000 rpm in a high-speed agitator, thereby preparing a coating solution. The thus-prepared coating solution was used to form a film having a thickness of 100 μm.

### (3) Comparative Example 1

A polyester resin was used to form a film having a thickness of 100 μm.

### (4) Comparative Example 2

10 g of carbon black having a mean aspect ratio (L/D) of 1 was added to 100 g of a polyester resin, and then the mixture was uniformly dispersed at a speed of 3000 rpm in a high-speed agitator, thereby preparing a coating solution. The thus-prepared coating solution was used to form a film having a thickness of 100 μm.

2. Evaluation of Vibration Damping Performance

On the films manufactured in the examples and the comparative examples, a dynamic mechanical analyzer (DMA) was used to measure a damping energy (loss modulus) for every 0.1% strain with a frequency of 10 hz at room temperature.

TABLE 1

| | | Damping energy (MPa) | | | |
|---|---|---|---|---|---|
| | | | | Comparative | |
| | | | Example 2 | Example 1 | Comparative |
| | | | Carbon nanotubes | — | Example 2 |
| | | Example 1 | (mean aspect | (mean aspect | Carbon black |
| | | Nanoclay | ratio = 100) | ratio = 500) | ratio = 1) |
| Strain | 0.1 | 16 | 20 | 13 | 13 |
| (%) | 0.2 | 20 | 25 | 14 | 13.5 |
| | 0.3 | 23 | 28 | 13 | 14.5 |
| | 0.4 | 28 | 33 | 14 | 14 |
| | 0.6 | 31 | 38 | 14 | 14 |
| | 0.8 | 33 | 39 | 14 | 15 |
| | 1.0 | 38 | 42 | 14 | 15 |
| | 1.2 | 39 | 46 | 13 | 15 |
| | 1.5 | 41 | 51 | 14 | 15 |

It is recognized that the films manufactured using the inorganic nanoparticles having a mean aspect ratio of 100 or more as in Examples 1 and 2 had a high damping energy value depending on a strain, and had a rapidly increased damping energy value with a higher strain. This means that though external force was applied to the film, vibrational energy was converted into thermal energy due to the viscoelastic properties of the polymer resin and a slip occurring in a polymer resin interface. That is, it is recognized from the results of measuring the damping energy that the coating solution composition including a polymer resin and inorganic nanoparticles having a mean aspect ratio of 100 or more according to the present disclosure may be applied to the manufacturing of a vibration damping steel sheet having excellent vibration damping performance.

1. A surface treatment composition for a vibration damping steel sheet comprising: a polymer resin and inorganic nanoparticles having a mean aspect ratio (L/D) of 100 or more.

2. The surface treatment composition for a vibration damping steel sheet of claim 1, wherein the polymer resin is one or more selected from the group consisting of an ethylene vinyl acetate resin, a polyethylene resin, a polypropylene resin, a polyvinyl butyral resin, a polyester resin, a polyvinyl chloride resin, and an epoxy resin.

3. The surface treatment composition for a vibration damping steel sheet of claim 1, wherein the inorganic nanoparticles are one or more selected from the group consisting of a graphite nanofiber, carbon nanotubes, nanoclay, and graphene.

4. The surface treatment composition for a vibration damping steel sheet of claim 1, wherein the inorganic nanoparticles are included at 0.1 to 20 parts by weight based on 100 parts by weight of the polymer resin.

5. A vibrational damping steel sheet comprising: a steel sheet, and a vibration damping layer containing the composition of claim 1 on at least one surface of the steel sheet.

6. A vibrational damping steel sheet of claim 5, wherein the polymer resin is one or more selected from the group consisting of an ethylene vinyl acetate resin, a polyethylene resin, a polypropylene resin, a polyvinyl butyral resin, a polyester resin, a polyvinyl chloride resin, and an epoxy resin.

7. A vibrational damping steel sheet of claim 5, wherein the inorganic nanoparticles are one or more selected from the group consisting of a graphite nanofiber, carbon nanotubes, nanoclay, and graphene.

8. A vibrational damping steel sheet of claim 5, wherein the inorganic nanoparticles are included at 0.1 to 20 parts by weight based on 100 parts by weight of the polymer resin.
